(19) United States
(12) Patent Application Publication
(10) Pub. No.: US 2025/0104370 A1
(43) Pub. Date: Mar. 27, 2025

(54) INFORMATION PROCESSING SYSTEM, NON-TRANSITORY COMPUTER READABLE MEDIUM, AND METHOD

(71) Applicant: FUJIFILM Business Innovation Corp., Tokyo (JP)

(72) Inventors: Yasuyuki TANAKA, Kanagawa (JP); Tomonari TAKAHASHI, Kanagawa (JP); Ryosuke HIGASHIKATA, Kanagawa (JP); Atsushi OGIHARA, Kanagawa (JP)

(73) Assignee: FUJIFILM Business Innovation Corp., Tokyo (JP)

(21) Appl. No.: 18/426,375

(22) Filed: Jan. 30, 2024

(30) Foreign Application Priority Data
Sep. 22, 2023 (JP) 2023-159131

(51) Int. Cl. G06T 19/20; G05B 19/4099

(52) U.S. Cl. CPC G06T 19/20; G05B 19/4099; G05B 2219/49023; G06T 2219/2016

(57) ABSTRACT

An information processing system includes a processor configured to: display product manufacturing information for only a representative one of plural features of a same shape included in a three-dimensional model represented by three-dimensional drawing data; and switch, if a preset condition is satisfied, between display of the product manufacturing information for only the representative one of the plural features and individual display of the product manufacturing information for each of the features.

### CROSS-REFERENCE TO RELATED APPLICATIONS

This application is based on and claims priority under 35 USC 119 from Japanese Patent Application No. 2023-159131 filed Sep. 22, 2023.

### BACKGROUND

### (i) Technical Field

The present disclosure relates to an information processing system, a non-transitory computer readable medium, and a method.

### (ii) Related Art

Japanese Unexamined Patent Application Publication No. 2002-328952 discloses an attribute information processing apparatus that, in a computer-aided design (CAD) apparatus, adds and displays created attribute information including dimensions and dimensional tolerances to and on a three-dimensional model.

### SUMMARY

Aspects of non-limiting embodiments of the present disclosure relate to an information processing system, a non-transitory computer readable medium, and a method capable of preventing occurrence of an event where, even when product manufacturing information (PMI) is displayed for only a representative one of plural features of the same shape included in a three-dimensional model represented by three-dimensional drawing data, the PMI regarding the features cannot be understood.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to: display product manufacturing information for only a representative one of a plurality of features of a same shape included in a three-dimensional model represented by three-dimensional drawing data; and switch, if a preset condition is satisfied, between display of the product manufacturing information for only the representative one of the plurality of features and individual display of the product manufacturing information for each of the plurality of features.

### BRIEF DESCRIPTION OF THE DRAWINGS

An exemplary embodiment of the present disclosure will be described in detail based on the following figures, wherein:

FIG. 1 is a diagram illustrating configuration of a drawing data processing system according to an exemplary embodiment of the present disclosure;

FIG. 2 is a diagram illustrating an example of three-dimensional drawing data including PMI;

FIG. 3 is a diagram illustrating how three holes of the same shape are provided for a three-dimensional model;

FIG. 4 is a diagram illustrating an example of display where the three-dimensional model illustrated in FIG. 3 is displayed on a display of a terminal apparatus;

FIG. 5 is a diagram illustrating an example of display where a part of the three-dimensional model displayed on the display illustrated in FIG. 4 is enlarged;

FIG. 6 is a block diagram illustrating hardware configuration of the terminal apparatus according to the exemplary embodiment of the present disclosure;

FIG. 7 is a block diagram illustrating functional configuration of the terminal apparatuses according to the exemplary embodiment of the present disclosure;

FIG. 8 is a diagram illustrating how a control unit generates a three-dimensional annotation (3DA) for each of eight features even when the same 3DA is set for the eight features;

FIG. 9 is a diagram illustrating how the control unit switches between collective display, where PMI is displayed for only a representative one of plural features of the same shape, and individual display, where PMI is individually displayed for each of plural features;

FIG. 10 is a diagram illustrating how the individual display is automatically performed as a result of enlargement;

FIG. 11 is a diagram illustrating an example of a display screen at a time when a switch button for switching between the collective display and the individual display is displayed on the display;

FIG. 12 is a diagram illustrating how the individual display is performed when a user uses the switch button in the state illustrated in FIG. 11;

FIG. 13 is a diagram illustrating another example of display at a time when a display format is switched between the collective display and the individual display; and

FIGS. 14A to 14C are diagrams illustrating various display methods at a time when the collective display is performed.

### DETAILED DESCRIPTION

Next, an exemplary embodiment of the present disclosure will be described in detail with reference to the drawings.

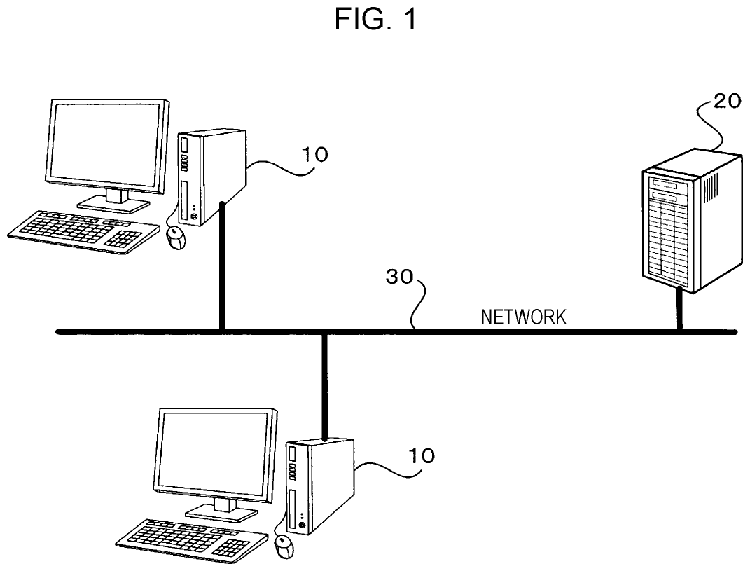

FIG. 1 is a diagram illustrating the configuration of a drawing data processing system according to the exemplary embodiment of the present disclosure.

As illustrated in FIG. 1, the drawing data processing system according to the exemplary embodiment of the present disclosure includes plural terminal apparatuses 10 and a drawing data management server 20 connected to one another over a network 30. The drawing data management server 20 manages drawing data, such as part drawings and product drawings, used when various products are designed. The terminal apparatuses 10 are information processing apparatuses having functions of downloading and displaying the drawing data managed by the drawing data management server 20, performing various operations, such as correction and modification, on the downloaded drawing data, and uploading the drawing data to the drawing data management server 20.

Here, the drawing data managed by the drawing data management server 20 is, for example, three-dimensional drawing data including not only product shape information indicating shapes of products to be formed but also specification information such as nominal sizes and tolerances as PMI.

During these years, in three-dimensional CAD, three-dimensional drawing data includes not only product shape information indicating shapes of products to be formed but also specification information, such as nominal sizes and tolerances, as PMI. In doing so, when a three-dimensional model is displayed, the PMI can be displayed in the three-dimensional model as three-dimensional annotations (hereinafter abbreviated as “3DAs”), and necessary information such as nominal sizes and tolerances can be understood without a two-dimensional drawing.

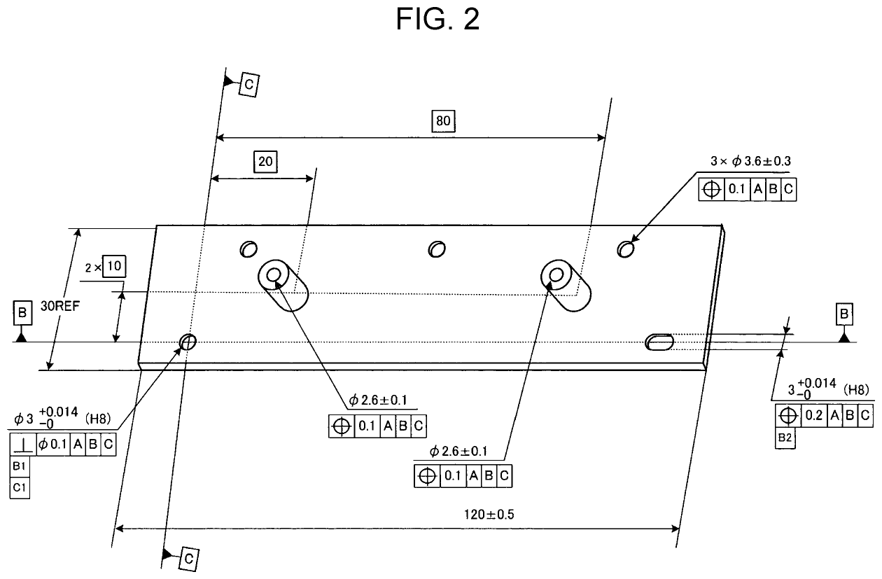

FIG. 2 illustrates an example of such three-dimensional drawing data including PMI. In FIG. 2, various pieces of PMI such as size tolerances, geometrical tolerances, and theoretically exact dimensions (TEDs) are displayed in a three-dimensional model as 3DAs.

When a three-dimensional model represented by three-dimensional drawing data is displayed along with PMI and a corresponding product includes plural features of the same shape, the PMI is displayed for only one of the plural features in order to reduce the number of pieces of PMI displayed and make displayed content easy-to-see. If the three-dimensional model of the product is enlarged and only a feature for which the PMI is not displayed remains in a display screen, it is difficult to understand the PMI regarding the feature.

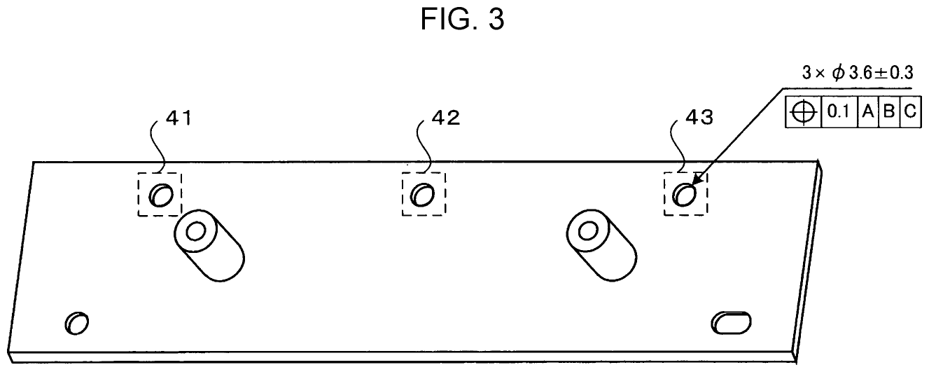

A case where, as illustrated in FIG. 3, three holes 41 to 43 are provided for a certain three-dimensional model, for example, will be described. In the following description, PMI regarding features other than the three holes 41 to 43 is omitted for simplicity of description.

Since the shapes of the three holes 41 to 43 are exactly the same in the three-dimensional model illustrated in FIG. 3, PMI regarding a size tolerance “3×φ3.6±0.3”, PMI regarding a geometrical tolerance, and the like are displayed for only the hole 43 among the three holes 41 to 43. An expression “3×” included in the size tolerance means that there is a total of three features of the same shape. PMI is omitted for the holes 41 and 42 other than the hole 43, for which the PMI is displayed.

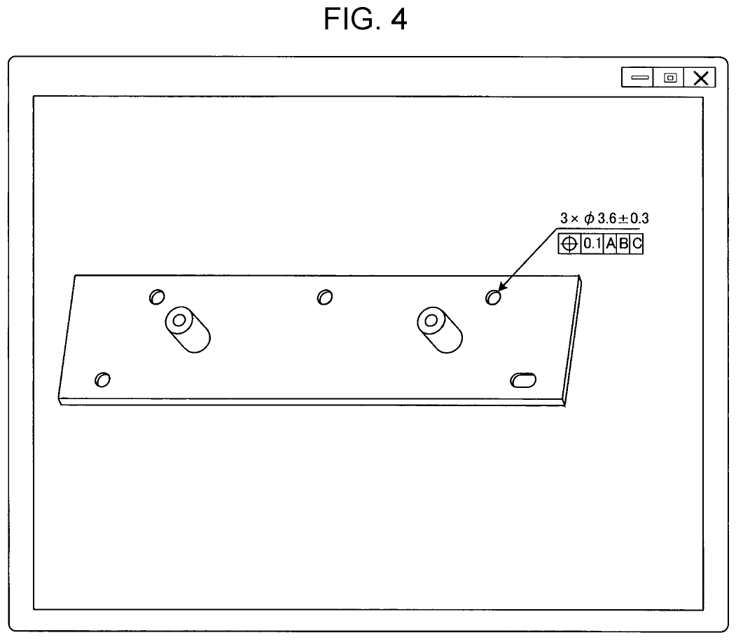

FIG. 4 illustrates an example of display where the three-dimensional model illustrated in FIG. 3 is displayed on a display of the terminal apparatus 10. In FIG. 4, PMI is displayed for only one of the three holes in the three-dimensional model.

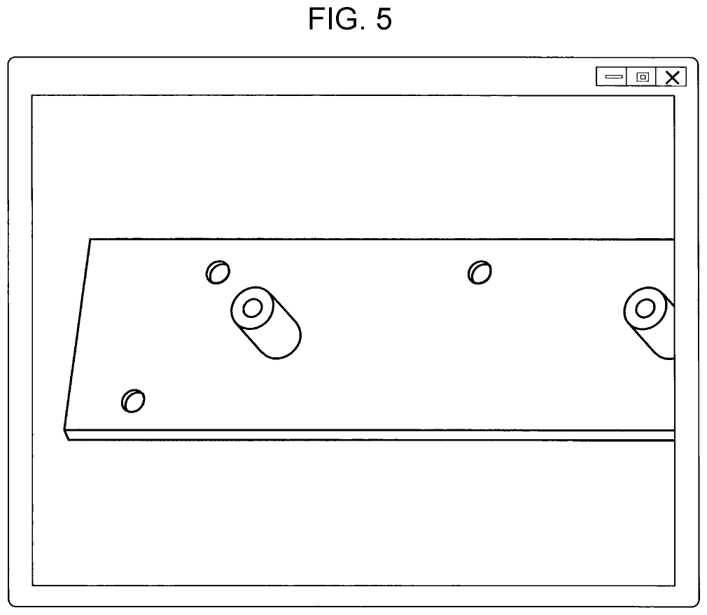

FIG. 5 illustrates an example of display where a part of the three-dimensional model displayed on the display illustrated in FIG. 4 is enlarged. In FIG. 5, the PMI displayed for only one of the three holes of the same shape is no longer displayed on the screen because of the enlargement of the three-dimensional model.

If only a part of a three-dimensional model is displayed as a result of enlargement after PMI is displayed for only one of plural features, the PMI displayed before the enlargement might no longer be displayed on a display screen, and it becomes difficult to understand the PMI regarding the features.

A designer or a developer of a product can recognize, among features in the product, a feature for which PMI is not displayed and that has the same shape as another feature for which PMI is displayed. As a result, the designer or the developer can understand the PMI regarding the feature for which the PMI is not displayed. When a quality checker or the like checks a three-dimensional model, however, it is difficult to recognize which features have the same shape, and as a result, it is difficult to understand PMI regarding features for which the PMI is not displayed.

In the drawing data processing system according to the present exemplary embodiment, therefore, control that will be described hereinafter is performed, and even when PMI is displayed for only a representative one of plural features of the same shape included in a three-dimensional model represented by three-dimensional drawing data, an event where it is difficult to understand the PMI regarding the features does not occur.

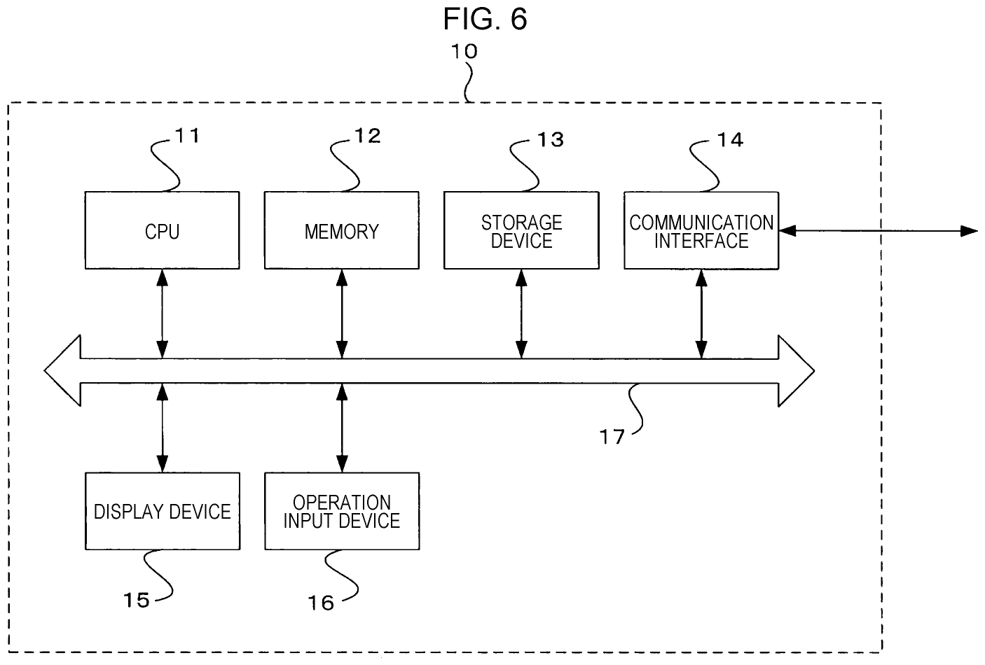

Next, FIG. 6 illustrates hardware configuration of the terminal apparatuses 10 in the drawing data processing system according to the present exemplary embodiment.

As illustrated in FIG. 6, the terminal apparatuses 10 each include a central processing unit (CPU) 11, a memory 12, a storage device 13 such as a hard disk drive, a communication interface 14 that transmits and receives data to and from external apparatuses and the like over the network 30, a display device 15 such as a liquid crystal display, and an operation input device 16 including a touch panel or a keyboard. These components are connected to one another through a control bus 17.

The CPU 11 is a processor that controls the operation of the terminal apparatus 10 by performing certain processing on the basis of a control program stored in the memory 12 or the storage device 13. Although the CPU 11 loads and executes the control program stored in the memory 12 or the storage device 13 in the present exemplary embodiment, the control program need not be stored in the memory 12 or the storage device 13. The control program may be stored in a computer readable medium and provided, instead. For example, the control program may be stored in an optical disc such as a compact disc read-only memory (CD-ROM) or a digital versatile disc read-only memory (DVD-ROM) or a semiconductor memory such as a universal serial bus (USB) memory or a memory card and provided, instead. Alternatively, the control program may be obtained from an external apparatus over a communication network connected to the communication interface 14.

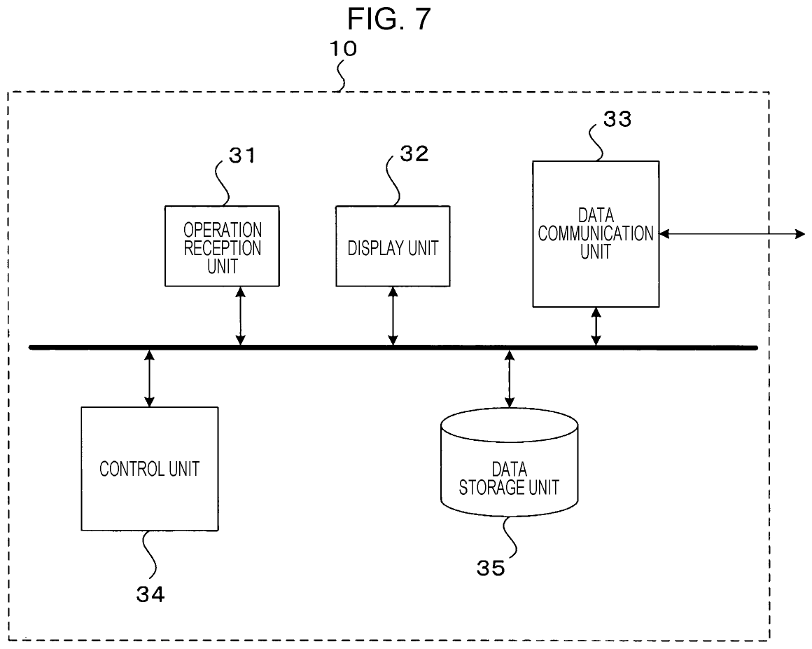

FIG. 7 is a block diagram illustrating functional configuration of the terminal apparatuses 10 achieved by executing the control program.

As illustrated in FIG. 7, the terminal apparatuses 10 according to the present exemplary embodiment each include an operation reception unit 31, a display unit 32, a data communication unit 33, a control unit 34, and a data storage unit 35.

The data communication unit 33 communicates data with external apparatuses including the drawing data management server 20.

The display unit 32 is controlled by the control unit 34 and displays various pieces of information for a user. The operation reception unit 31 receives various operations performed by the user.

The control unit 34 receives drawing data from the drawing data management server 20 through the data communication unit 33, stores the drawing data in the data storage unit 35, and displays the drawing data stored in the data storage unit 35 on the display unit 32. The control unit 34 also modifies the drawing data stored in the data storage unit 35 on the basis of a user operation received by the operation reception unit 31 and uploads the modified drawing data to the drawing data management server 20 through the data communication unit 33.

Even when the PMI displayed as a representative 3DA is set for plural features of the same shape, the control unit 34 according to the present exemplary embodiment internally generates and saves PMI displayed as an individual 3DA for each of the plural features.

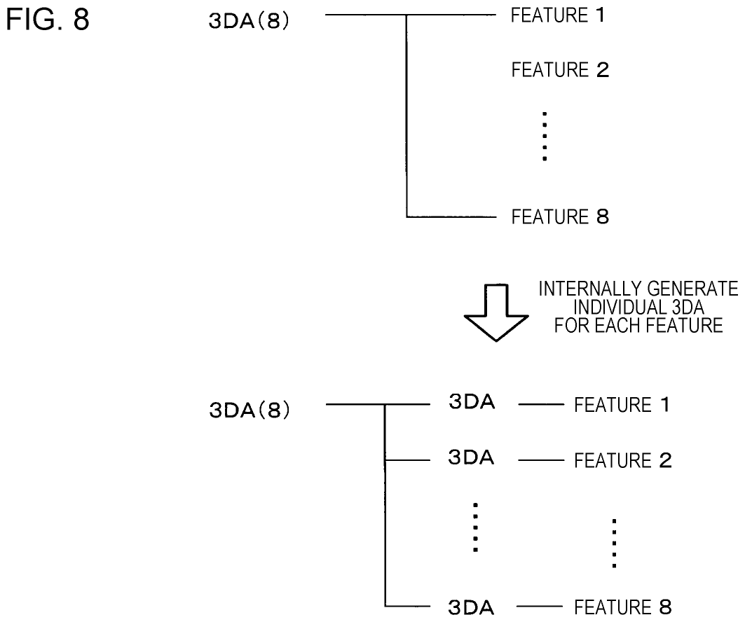

More specifically, even when the same 3DA (8) is set for eight features 1 to 8, the control unit 34 generates and saves the 3DA for each of the eight features 1 to 8 as illustrated in FIG. 8.

In a normal state, the control unit 34 displays PMI for only a representative one of plural features of the same shape included in a three-dimensional model represented by three-dimensional drawing data. If a preset condition is satisfied, the control unit 34 switches between display of the PMI for only the representative one of the plural features and display of the PMI for each of the plural features.

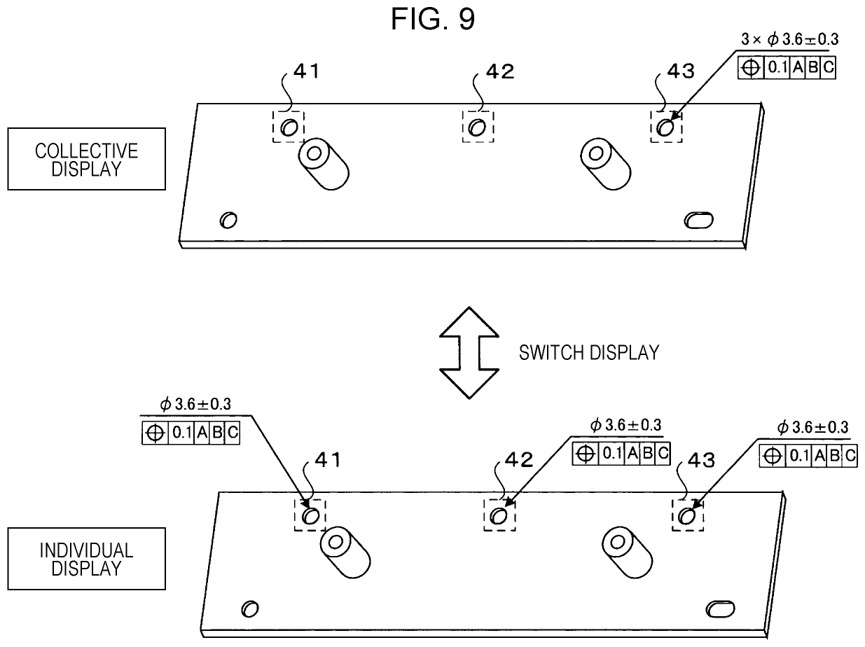

FIG. 9 illustrates how the control unit 34 switches between collective display, where PMI is displayed for only a representative one of plural features of the same shape, and individual display, where PMI is individually display for each of plural features.

In FIG. 9, when the collective display is performed, PMI is displayed for only the hole 43 among the three holes 41 to 43, and when the individual display is performed, PMI is displayed for each of the three holes 41 to 43.

If the preset condition is satisfied, the control unit 34 switches between the collective display and the individual display.

For example, the control unit 34 switches, in accordance with how a three-dimensional model represented by three-dimensional drawing data is displayed, between display of PMI for only a representative one of plural features and individual display of PMI for each of plural features.

More specifically, if a part of a displayed three-dimensional model of a product is enlarged and PMI that has been displayed for only a representative one of plural features is no longer displayed on a display screen, the control unit 34 individually displays the PMI, which has been displayed for only the representative one of the plural features, for each of the plural features.

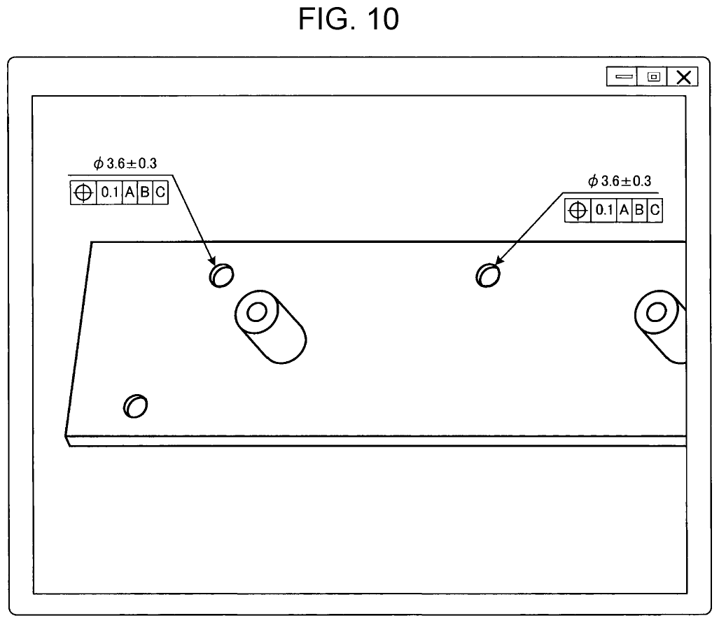

That is, even when the entirety of a three-dimensional model is displayed on a display as illustrated in FIG. 4 and the control unit 34 performs the collective display, where PMI is displayed for only one feature, the control unit 34 automatically switches to the individual display if the feature for which the PMI has been displayed is no longer displayed on the display as illustrated in FIG. 10. In FIG. 10, therefore, the PMI is individually displayed for the other two holes, for which the PMI has not been displayed in the collective display. As a result, an event where it becomes difficult to understand PMI regarding features in a three-dimensional model as a result of enlargement does not occur.

In addition, for example, the control unit 34 may switch, in accordance with an attribute of a user who has displayed a three-dimensional model represented by three-dimensional drawing data, between display of PMI for only a representative one of plural features or individual display of PMI for each of plural features.

More specifically, the control unit 34 switches between display of PMI for only a representative one of plural features or individual display of PMI for each of plural features in accordance with a department to which a user who has displayed a three-dimensional model represented by three-dimensional drawing data belongs.

A user who belongs to a design department, for example, is usually able to easily recognize, among plural features, which features have the same shape because the user is usually familiar with parts to be designed. It is often difficult, however, for a user who belongs to an inspection department or a quality management department to recognize, among plural features, which features have the same shape because the user usually handles unspecified parts. When a user who has displayed a three-dimensional model belongs to the design department, therefore, the collective display may be performed. When a user who has displayed a three-dimensional model belongs to a department other than the design department, such as the inspection department or the quality management department, on the other hand, the individual display may be performed, in order to prevent an event where a user who is not familiar with individual parts has trouble understanding PMI regarding features displayed in a three-dimensional model.

Furthermore, for example, the control unit 34 may switch, in accordance with a development step when a three-dimensional model represented by three-dimensional drawing data is displayed, between display of PMI for only a representative one of plural features or individual display of PMI for each of plural features.

More specifically, if a development step when a three-dimensional model represented by three-dimensional drawing data is displayed is a design step, the control unit 34 displays PMI for only a representative one of plural features, and if a development step when a three-dimensional model represented by three-dimensional drawing data is displayed is a step other than the design step, such as an inspection step or a quality management step, the control unit 34 individually displays PMI that has been displayed for only a representative one of plural features for each of plural features.

Furthermore, for example, the control unit 34 may switch, in accordance with an operation history of a user who has displayed a three-dimensional model represented by three-dimensional drawing data, between display of PMI for only a representative one of plural features or individual display of PMI for each of plural features.

More specifically, when displaying a three-dimensional model, the control unit 34 automatically performs the collective display for a user who has, according to an operation history, often selected the collective display and the individual display for a user who has, according to an operation history, often selected the individual display.

Furthermore, the control unit 34 may switch, in accordance with an operation performed by a user who has displayed a three-dimensional model represented by three-dimensional drawing data, between display of PMI for only a representative one of plural features or individual display of PMI for each of plural features.

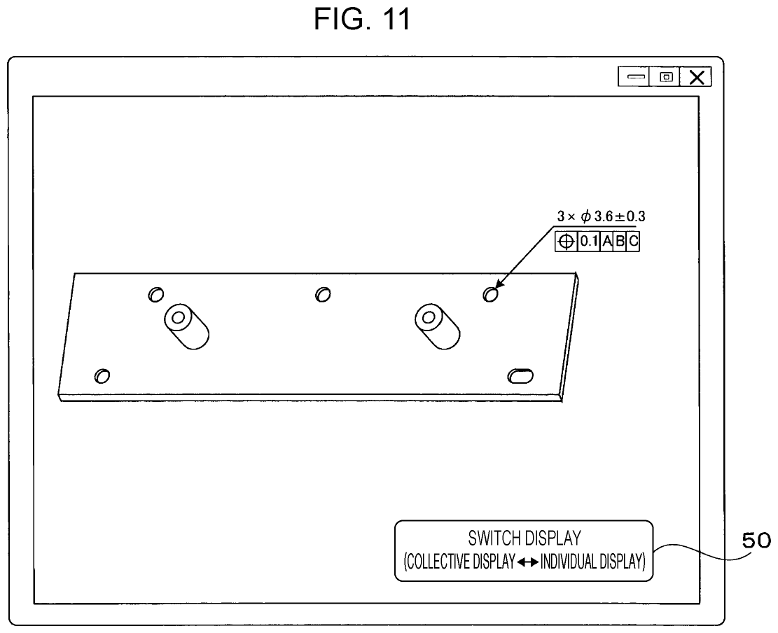

As illustrated in FIG. 11, for example, a switch button 50 for switching between the collective display and the individual display may be displayed on the display, and when the user uses the switch button 50, the collective display and the individual display may be switched. If PMI is selected, a display method may be switched for only the PMI, and if PMI is not selected, the display method may be switched for all PMI.

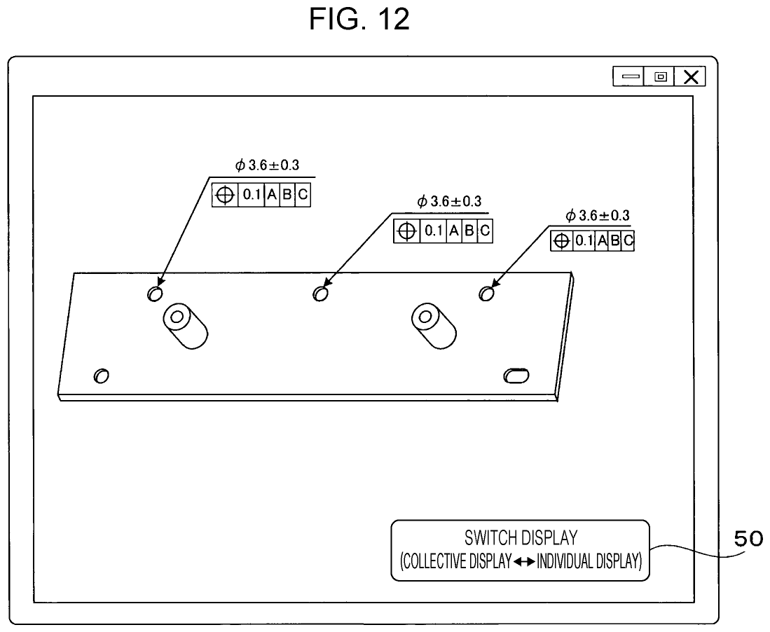

Although the collective display, where PMI is displayed for only one of plural features, is performed in an example of a display screen illustrated in FIG. 11, individual display illustrated in FIG. 12 is performed if a user uses the switch button 50 in this state. In an example of a display screen illustrated in FIG. 12, the individual display, where PMI is individually displayed for each of plural features, is performed.

Even a user who belongs to the design department might handle, during inspection of drawings, parts that have been designed by others and that the user is unfamiliar with, and there are also users who are not familiar with three-dimensional models. When a three-dimensional model includes a large number of features, even an experienced user might find it difficult to recognize which features have the same shape. Display based on a user's intention, therefore, is performed by switching between the collective display and the individual display in accordance with a user operation.

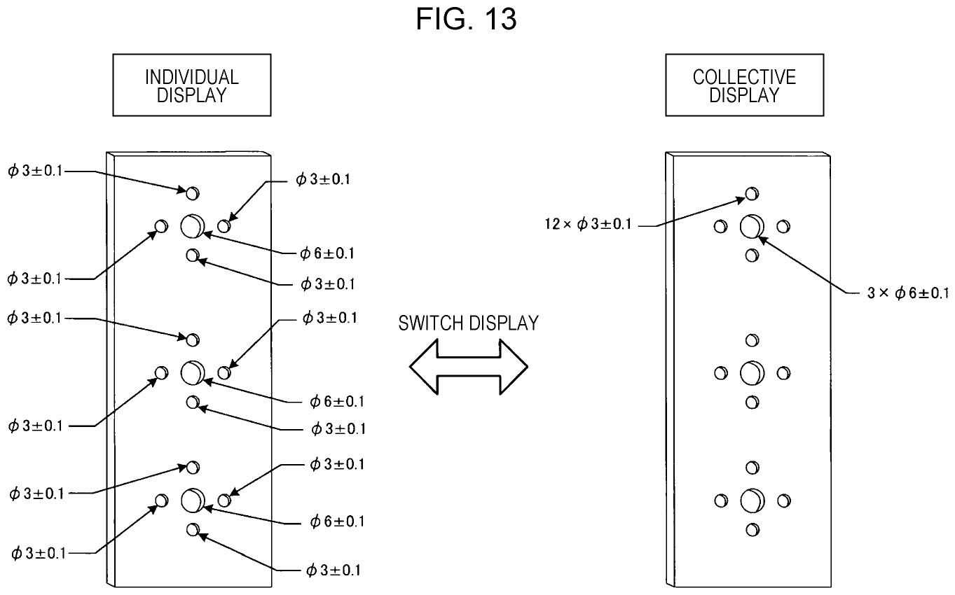

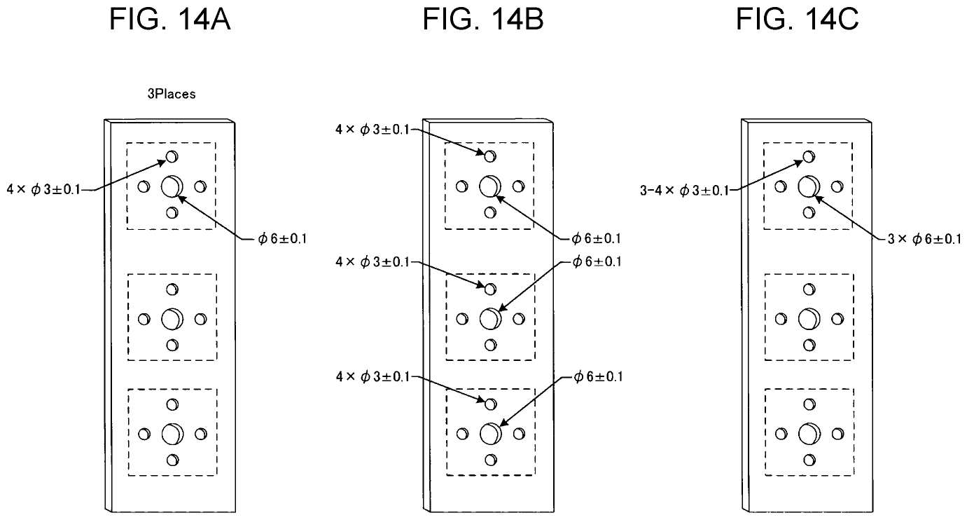

Although a case where a display format is switched between the collective display and the individual display for the three holes 41 to 43 has been described above, various display methods employed when the collective display is performed will be described with reference to FIGS. 13 and 14.

FIG. 13 illustrates an example of display at a time when the display format is switched between the collective display and the individual display in an example of a three-dimensional model including three holes of 6 mm in diameter and twelve holes of 3 mm in diameter.

FIGS. 14A to 14C are diagrams illustrating various display methods of the collective display in this case.

In an example of display illustrated in FIG. 14A, a term “3 places” indicates that the three-dimensional model includes three sets of dimensions.

FIGS. 14B and 14C illustrate examples of description where it is described that the three-dimensional model includes three sets of dimensions. In FIG. 14B, PMI “4×φ3±0.1” and PMI “φ6±0.1” are displayed for each of the three sets of dimensions. In FIG. 14C, PMI “3−4×φ3±0.1” and PMI “3×φ6±0.1” are displayed for only one of the three sets of dimensions.

Although not described above, when the collective display is performed and PMI is displayed for only one of plural features, a display method might be employed where only a bracketed nominal size or a nominal size with a word “REF” are displayed for the other features. More specifically, there is a display method where “3×φ3.6±0.3”, which indicates a nominal size, a dimensional tolerance, and a fact that there are three features of the same shape, is displayed for one of the three holes, and “(φ3.6)” or “φ3.6 REF”, which indicates the nominal size and information indicating that the dimensional tolerance for another feature of the same shape is to be referred to, is displayed for the other two holes.

The collective display and the individual display are not simultaneously performed for PMI, and either the collective display or the individual display can be performed.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The term “system” in the present embodiment includes both a system achieved by plural apparatuses and a system achieved by a single apparatus.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An information processing system including:
a processor configured to:
   display product manufacturing information for only a representative one of a plurality of features of a same shape included in a three-dimensional model represented by three-dimensional drawing data; and
   switch, if a preset condition is satisfied, between display of the product manufacturing information for only the representative one of the plurality of features and individual display of the product manufacturing information for each of the plurality of features.
      (((2)))

The information processing system according to (((1))),
in which the processor is configured to switch, in accordance with how the three-dimensional model represented by the three-dimensional drawing data is displayed, between the display of the product manufacturing information for only the representative one of the plurality of features and the individual display of the product manufacturing information for each of the plurality of features.
   (((3)))

The information processing system according to (((2))),
in which the processor is configured to individually display the product manufacturing information for each of the plurality of features if a part of the displayed three-dimensional model of a product is enlarged and the product manufacturing information that has been displayed for only the representative one of the plurality of features is no longer displayed.
   (((4)))

The information processing system according to (((1))),
in which the processor is configured to switch, in accordance with an attribute of a user who has displayed the three-dimensional model represented by the three-dimensional drawing data, between the display of the product manufacturing information for only the representative one of the plurality of features and the individual display of the product manufacturing information for each of the plurality of features.
   (((5)))

The information processing system according to (((1))),
in which the processor is configured to switch, in accordance with a development step when the three-dimensional model represented by the three-dimensional drawing data is displayed, between the display of the product manufacturing information for only the representative one of the plurality of features and the individual display of the product manufacturing information for each of the plurality of features.
   (((6)))

The information processing system according to (((5))),
in which the processor is configured to display the product manufacturing information for only the representative one of the plurality of features if the development step when the three-dimensional model represented by the three-dimensional drawing data is displayed is a design step and, if the development step when the three-dimensional model represented by the three-dimensional drawing data is displayed is a step other than the design step, individually display the product manufacturing information that has been displayed for only the representative one of the plurality of features for each of the plurality of features.
   (((7)))

The information processing system according to (((1))),
in which the processor is configured to switch, in accordance with an operation history of a user who has displayed the three-dimensional model represented by the three-dimensional drawing data, between the display of the product manufacturing information for only the representative one of the plurality of features and the individual display of the product manufacturing information for each of the plurality of features.
   (((8)))

The information processing system according to (((1))),
in which the processor is configured to switch, in accordance with an operation performed by a user who has displayed the three-dimensional model represented by the three-dimensional drawing data, between the display of the product manufacturing information for only the representative one of the plurality of features and the individual display of the product manufacturing information for each of the plurality of features.
   (((9)))

A program causing a computer to execute a process including displaying product manufacturing information for only a representative one of a plurality of features of a same shape included in a three-dimensional model represented by three-dimensional drawing data and switching, if a preset condition is satisfied, between display of the product manufacturing information for only the representative one of the plurality of features and individual display of the product manufacturing information for each of the plurality of features.

What is claimed is:

1. An information processing system comprising:
a processor configured to:
display product manufacturing information for only a representative one of a plurality of features of a same shape included in a three-dimensional model represented by three-dimensional drawing data; and
switch, if a preset condition is satisfied, between display of the product manufacturing information for only the representative one of the plurality of features and individual display of the product manufacturing information for each of the plurality of features.

2. The information processing system according to claim 1,
wherein the processor is configured to switch, in accordance with how the three-dimensional model represented by the three-dimensional drawing data is displayed, between the display of the product manufacturing information for only the representative one of the plurality of features and the individual display of the product manufacturing information for each of the plurality of features.

3. The information processing system according to claim 2,
wherein the processor is configured to individually display the product manufacturing information for each of the plurality of features if a part of the displayed three-dimensional model of a product is enlarged and the product manufacturing information that has been displayed for only the representative one of the plurality of features is no longer displayed.

4. The information processing system according to claim 1,
wherein the processor is configured to switch, in accordance with an attribute of a user who has displayed the three-dimensional model represented by the three-dimensional drawing data, between the display of the product manufacturing information for only the representative one of the plurality of features and the individual display of the product manufacturing information for each of the plurality of features.

5. The information processing system according to claim 1,
wherein the processor is configured to switch, in accordance with a development step when the three-dimensional model represented by the three-dimensional drawing data is displayed, between the display of the product manufacturing information for only the representative one of the plurality of features and the individual display of the product manufacturing information for each of the plurality of features.

6. The information processing system according to claim 5,
wherein the processor is configured to display the product manufacturing information for only the representative one of the plurality of features if the development step when the three-dimensional model represented by the three-dimensional drawing data is displayed is a design step and, if the development step when the three-dimensional model represented by the three-dimensional drawing data is displayed is a step other than the design step, individually display the product manufacturing information that has been displayed for only the representative one of the plurality of features for each of the plurality of features.

7. The information processing system according to claim 1,
wherein the processor is configured to switch, in accordance with an operation history of a user who has displayed the three-dimensional model represented by the three-dimensional drawing data, between the display of the product manufacturing information for only the representative one of the plurality of features and the individual display of the product manufacturing information for each of the plurality of features.

8. The information processing system according to claim 1,
wherein the processor is configured to switch, in accordance with an operation performed by a user who has displayed the three-dimensional model represented by the three-dimensional drawing data, between the display of the product manufacturing information for only the representative one of the plurality of features and the individual display of the product manufacturing information for each of the plurality of features.

9. A non-transitory computer readable medium storing a program causing a computer to execute a process comprising:
displaying product manufacturing information for only a representative one of a plurality of features of a same shape included in a three-dimensional model represented by three-dimensional drawing data; and
switching, if a preset condition is satisfied, between display of the product manufacturing information for only the representative one of the plurality of features and individual display of the product manufacturing information for each of the plurality of features.

10. A method comprising:
displaying product manufacturing information for only a representative one of a plurality of features of a same shape included in a three-dimensional model represented by three-dimensional drawing data; and
switching, if a preset condition is satisfied, between display of the product manufacturing information for only the representative one of the plurality of features and individual display of the product manufacturing information for each of the plurality of features.
